(19) United States
(12) Patent Application Publication
(10) Pub. No.: US 2019/0145141 A1
(43) Pub. Date: May 16, 2019

(54) CLOSER APPARATUS

(71) Applicant: FIRSTCLOSER. CO. LTD., Yongin-si (KR)

(72) Inventor: Yongjun JO, Yongin-si (KR)

(21) Appl. No.: 16/098,490

(22) PCT Filed: May 12, 2017
(86) PCT No.: PCT/KR2017/004921

§ 371 Date: Nov. 2, 2018

(30) Foreign Application Priority Data
May 12, 2016 (KR) 10-2016-0057872
May 12, 2016 (KR) 10-2016-0057874
May 12, 2016 (KR) 10-2016-0057880

(51) Int. Cl. E05D 11/08; E05F 3/08; E05F 3/14; E05F 3/20; E06B 3/36

(52) U.S. Cl. CPC E05D 11/08; E05F 3/08; E05F 3/14; E05Y 2201/264; E06B 3/36; E05Y 2900/132; E05Y 2201/21; E05F 3/20

(57) ABSTRACT

The closer according to the present disclosure, which is installed on a door, can control damping force applied to the door in a stepwise manner through coupling to the damping device, the damping chamber, and the torsion device, and has a simple configuration, thereby providing advantages in which durability is excellent and lifespan is long. Furthermore, the damping device of the closer can be easily manufactured, can reduce manufacturing costs, can improve the reliability of the accurate regulation and damping operation of working fluid, and can accurately control of the resistance of the working fluid. The damping chamber of the closer can facilitate the formation of a flow path for working fluid, can accurately control the resistance of the working fluid, and can enable the control of the resistance of the working fluid to be easily performed on an interval basis.

### TECHNICAL FIELD

The present invention relates to a closer apparatus. More specifically, the present invention relates to the damping device, damping chamber, and torsion device of a closer.

### BACKGROUND ART

Generally, a closer is installed on a door or the like. A closer is an apparatus that enables a door to be rotated and closed for itself when force applied to a door is removed after the door has been opened by rotating the door. Such a closer includes a damping device configured to generate damping force by means of working fluid and a torsion device configured to generate restoring force by means of a spring.

As a damping device for a closer, Korean Patent Application Publication No. 10-2012-0124938 proposes a “rotary type damper.” The rotary type damper includes: a housing configured to be filled with working fluid; a shaft configured to be rotatably installed through the housing; a housing pin configured to be provided on the inner circumferential surface of the housing to reach the side of the shaft and to limit the movement of the working fluid; and an axis pin configured to be coupled to the shaft to be rotated along with the shaft, and configured such that the position thereof is varied depending the direction in which the shaft is rotated and thus the axis pin comes into tight contact with the side of the shaft and the inner circumferential surface of the housing.

However, when this conventional rotary type damper is actually manufactured, it has a limitation on the accurate control of the resistance of working fluid because it is difficult to control the operation of the housing pin and the axis pin. Accordingly, problems arise in that it is difficult to accurately regulate working fluid and the reliability of a damping operation is degraded.

As a conventional technology torsion device for a closer, Korean Patent Application Publication No. 10-2011-0103510 proposes a “door hinge having torsion unit.” The door hinge having torsion unit is a door hinge configured to be mounted on a door and the upper or lower portion of a door frame and configured such that the door is automatically returned after being opened. The door hinge includes a torsion unit configured to apply rotational force to a torsion spring and enable the door to be automatically returned after being opened. The torsion unit includes: a torsion shaft configured such that a groove is formed at one end thereof to be combined with a torsion spring, a head is formed at the other end thereof to be rotated in a single direction, a cylindrical shape is formed between the two ends, and a groove is formed on one side thereof; a guide rack configured such that it is formed in a hollow shape, grooves having a predetermined shape are successively formed on the inner surface of the hollow thereof in a circumferential direction, and one or more protrusions are formed on the outer surface of the hollow thereof; a guide rack fastening part including a guide rack key configured such that it has an internal hole, one end thereof is formed in a protrusion shape and is thus seated in the groove formed on the guide rack, and the other end thereof is coupled to a groove formed on the body of the torsion shaft and thus restrains the torsion shaft in a circumferential direction, thereby allowing rotation only in a single direction, and a fastening pin configured to be fitted into the hole formed in the guide rack key; a push spring configured to be disposed below the guide rack and to move together when the guide rack moves vertically; and a torsion housing configured such that the inside thereof is empty so that the push spring, the guide rack, and the torsion shaft can be seated therein, and one or more grooves are formed therein in an axial direction, thereby preventing the guide rack from being rotated in a circumferential direction.

However, this conventional technology does not take into account the accumulation of the elastic force of the spring, the reliability of a restoring operation using the accumulation, and structural durability, and needs to eliminate difficulty with actual manufacture and reduce manufacturing costs.

### DISCLOSURE

### Technical Problem

Therefore, an object of the present invention is to avoid the requirement of relatively high precision by avoiding the use of complicated components, such as a conventional housing pin and a conventional axis pin, thereby facilitating manufacture and also reducing manufacturing costs.

Furthermore, an object of the present invention is to improve the reliability of the accurate regulation and damping operation of working fluid and to precisely control the resistance of the working fluid.

Furthermore, an object of the present invention is to facilitate the formation of a flow path for working fluid by being easily assembled in a housing part, and to avoid the requirement of relatively high precision, thereby facilitating manufacture, reducing manufacturing costs, contributing to the improvement of the reliability of the accurate regulation and damping operation of working fluid, accurately controlling the resistance of the working fluid, and easily controlling the resistance of the working fluid on an interval basis.

Furthermore, an object of the present invention is to improve the reliability of the accumulation of the elastic force of a spring and the reliability of a restoring operation using the accumulation, to contribute to the enhancement of structural durability, and to reduce manufacturing difficulty and manufacturing costs.

Other objects of the present invention will be readily understood via the following description of embodiments.

### Technical Solution

In order to accomplish the above objects, according to an aspect of the present disclosure, there is provided a closer including a damping device, the damping device including: a damping housing configured such that both ends thereof are sealed by first and second sealing parts, and such that connection flow paths configured to connect a center portion in a lengthwise direction with an edge is formed in the first sealing part; a piston configured to pass through the second sealing part and to be inserted into the damping housing, and provided with a head to be subject to pressure of working fluid; and a damping chamber configured such that an internal space thereof is divided into first and second spaces in contact with the first and second sealing parts, respectively, by the head, and such that a flow path for working fluid is provided between the first and second spaces.

The closer further may include a torsion device configured to be coupled to the damping device, and the torsion device may include: a sliding member configured to be coupled to the piston of the damping device so that they can reciprocate together; and a rotating member configured to be fitted over the piston, to be inserted into the sliding member, to be installed to rotate relative to the sliding member.

The connection flow paths of the damping housing of the damping device may be formed to connect the center portion of a side directed toward the piston with an edge within the first sealing part, the damping chamber may be fastened to an inside of the damping housing so that the head is inserted thereinto, the first space may be connected to a center portion of the connection flow paths, and the main flow paths may be formed to connect an edge side of the connection flow paths, which is blocked by an end, with the second space, thereby providing a flow path for the working fluid between the first and second spaces for damping, and the damping device further includes a unidirectional control unit provided in the piston and configured to allow the working fluid to move between the first and second spaces in a single direction while the piston is moving.

The damping housing may be screwed to the first sealing part such that a damping adjustment bolt configured to adjust an extent to which the connection flow paths are opened and closed is exposed to the outside.

The connection flow paths may include: a first connection flow path formed in the center portion of the first sealing part to be connected to the first space; at least one second connection flow path formed to extend from the first connection flow path to an edge of the first sealing part; and a third connection flow path formed along an edge on a side of the first sealing part in contact with the damping chamber to be connected to the second connection flow path.

The main flow paths may include: a connection hole formed through a side of the damping chamber to connect the second space with the outside; and a flow path groove formed through an outer surface of the damping chamber in a lengthwise direction to connect the connection hole with the edge side of the connection flow paths.

One or more adjustment flow paths may be formed on the inner circumferential surface of the damping chamber so that the working fluid can move between the first and second space by bypassing the head.

The unidirectional control unit may include: control flow paths formed in the piston to connect the first and second spaces with each other; and a check valve configured to be installed in the control flow paths and to allow movement in a single direction from the first space to the second space.

The damping chamber may include: a body; and main flow paths including a connection hole formed in a side of the body to connect the second space with the outside, and a flow path groove formed on an outer surface of the body to connect the connection hole with the first space, thereby providing a flow path for the working fluid separate from the head that reciprocates.

The body may include a cylindrical member having both open ends; and the flow path groove may be formed through surface shaving on the outer surface of the body to extend from the connection hole to an end.

The main flow paths may connect the first and second spaces with each other in association with the connection flow paths in such a manner that the flow path groove is connected to the connection flow paths formed to be connected to the first space and the edge side within the first sealing part that blocks one end of the damping housing.

One or more adjustment flow paths may be formed on an inner circumferential surface of the damping chamber so that the working fluid can move between the first and second space by bypassing the head.

The damping chamber may be configured such that the adjustment flow paths are plural in number and partially overlap each other based on a direction in which the head reciprocates.

The torsion device may include: a torsion housing part fastened to any one hinge of a hinge apparatus; and a spring installed within the torsion housing part in a lengthwise direction to provide elastic force; the sliding member may be installed to be elastically supported on the spring and to reciprocate in the lengthwise direction in a state in which rotation of the sliding member has been suppressed within the torsion housing part; the rotating member may be fastened on a remaining hinge of the hinge apparatus; the torsion device may further include a rotational movement conversion unit configured to convert rotational movement of the rotating member and rectilinear movement of the sliding member into each other in such a manner that guide protrusions are formed on any one of fitting portions of the sliding member and the rotating member to be inclined with respect to a reciprocating direction and guide grooves configured to be combined with the guide protrusions are formed on a remaining one of the fitting portions of the sliding member and the rotating member to be inclined with respect to the reciprocating direction; and, when the door on which the hinge apparatus is installed is opened, the sliding member may be moved by relative rotation of the rotating member and the sliding member and compresses the spring, and, when force applied to the door is removed, the door may be closed by relative rotation of the sliding member and the rotating member based on returning of the sliding member attributable to the spring.

The torsion housing part may be configured such that a plurality of sliding grooves is formed on an inner circumferential surface of the torsion housing part in a lengthwise direction so that the sliding member can be slidably coupled to an inner side of the torsion housing part, screw grooves are formed on an inner circumferential surface of an end of the torsion housing part, and a tension adjustment bolt configured to support the spring in the screw grooves and to adjust tension of the spring according to an amount of rotation is screwed to the torsion housing part.

Sliding protrusions configured to be slidably coupled into the sliding grooves in a state in which the rotation thereof has been suppressed may be formed on the circumferential surface of the sliding member.

At least one fastening protrusion configured to be fastened to the housing of the hinge apparatus may be formed on the outer surface of each of the torsion housing part and the rotating member.

The rotational movement conversion unit may be configured such that the guide protrusions are formed along an outer circumferential surface of a fitting portion of the rotating member and the guide grooves are formed on a portion of the sliding member, into which the fitting portion is fitted, to correspond to the respective guide protrusions.

A plurality of stop protrusions may be formed along an end of the sliding member so that the guide protrusions separated from the guide grooves are caught on the stop protrusions and thus the closing of the door is stopped until external force is applied to the door.

According to an aspect of the present disclosure, there is provided a damping device for a closer, the damping device including: a damping housing configured such that both ends thereof are sealed by first and second sealing parts, and such that connection flow paths configured to connect a center portion in a lengthwise direction with an edge is formed in the first sealing part; a piston configured to pass through the second sealing part and to be inserted into the damping housing, and provided with a head to be subject to pressure of working fluid; and a damping chamber configured such that an internal space thereof is divided into first and second spaces in contact with the first and second sealing parts, respectively, by the head, and such that a flow path for working fluid is provided between the first and second spaces.

In this case, the damping chamber may be fastened to an inside of the damping housing, the first space may be connected to a center portion of the connection flow paths, and the main flow paths may be formed to connect an edge side of the connection flow paths, which is blocked by an end, with the second space, thereby providing a flow path for the working fluid between the first and second spaces for damping.

### Advantageous Effects

The closer according to the present disclosure, which is installed on a door, can control damping force applied to the door in a stepwise manner through coupling to the damping device, the damping chamber, and the torsion device, and has a simple configuration, thereby providing advantages in which durability is excellent and lifespan is long.

More specifically, the damping device of the closer according to the present disclosure can be easily manufactured, can reduce manufacturing costs, can improve the reliability of the accurate regulation and damping operation of working fluid, and can accurately control of the resistance of the working fluid.

The damping chamber of the closer according to the present disclosure can facilitate the formation of a flow path for working fluid, can accurately control the resistance of the working fluid, and can enable the control of the resistance of the working fluid to be easily performed on an interval basis.

The torsion device according to the present disclosure can be easily manufactured, can reduce manufacturing costs, and can improve the reliability of the accurate restoring force and torsion operation of the spring.

### DESCRIPTION OF DRAWINGS

FIG. 1 is an exploded perspective view showing a closer according to one embodiment of the present invention, which shows a state in which the closer has been closed;

FIG. 2 is a perspective view showing a hinge apparatus having the closer according to the one embodiment of the present invention;

FIG. 3 is a sectional view showing the closer according to the one embodiment of the present invention, which shows a state in which the closer has been closed;

FIG. 4 is an exploded perspective view showing the principal portion of the damping device of the closer according to the one embodiment of the present invention;

FIG. 5 is a perspective view showing the damping chamber of the damping device of the closer according to the one embodiment of the present invention;

FIG. 6 is an exploded perspective view showing the damping housing of the damping device of the closer according to the one embodiment of the present invention;

FIG. 7 is an exploded perspective view showing the torsion device of the closer according to the one embodiment of the present invention;

FIG. 8 is an exploded perspective view showing the rotational movement conversion unit of the closer according to the one embodiment of the present invention;

FIG. 9 is a perspective view showing the torsion housing part of the closer according to the one embodiment of the present invention;

FIG. 10 is a sectional view showing a state in which the closer according to the one embodiment of the present invention has been opened by 45 degrees; and

FIG. 11 is a sectional view showing a state in which the closer according to the one embodiment of the present invention has been opened by 90 degrees.

### MODE FOR INVENTION

The present invention may be subject to various modifications, and may have various embodiments. Specific embodiments will be illustrated in the drawings, and will be described in detail. However, this is not intended to limit the present invention to specific embodiments. All modifications, equivalents, and substitutions included in the technical spirit and technical scope of the present invention should be understood as being included in the present invention. The present invention may be modified in various different forms. The scope of the present invention is not limited to the following embodiments.

Embodiments according to the present invention will be described in detail below with reference to the accompanying drawings. Regardless of the numbers of the drawings, the same or corresponding components will be denoted by the same reference symbols, and redundant descriptions thereof will be omitted.

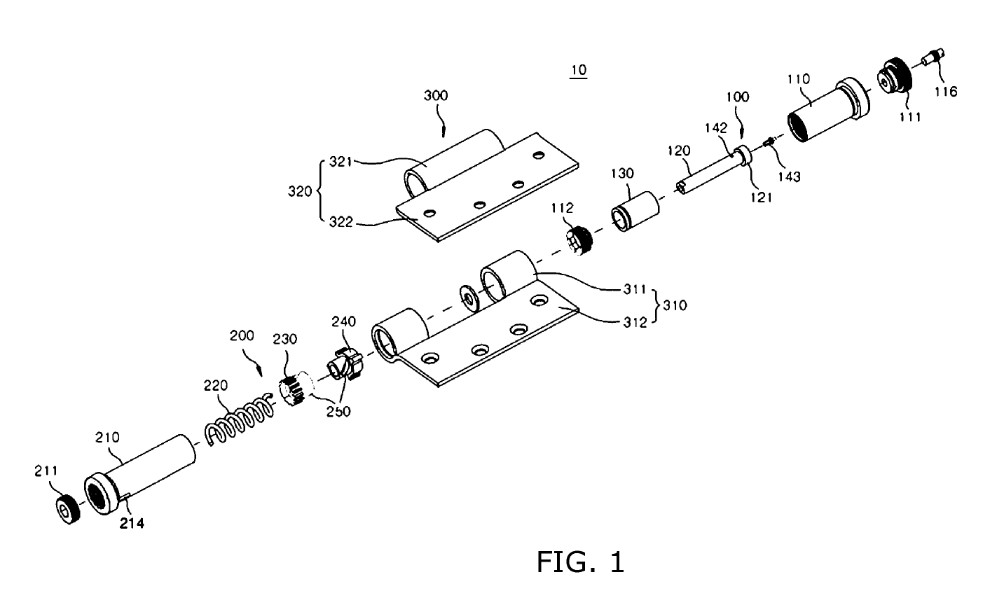

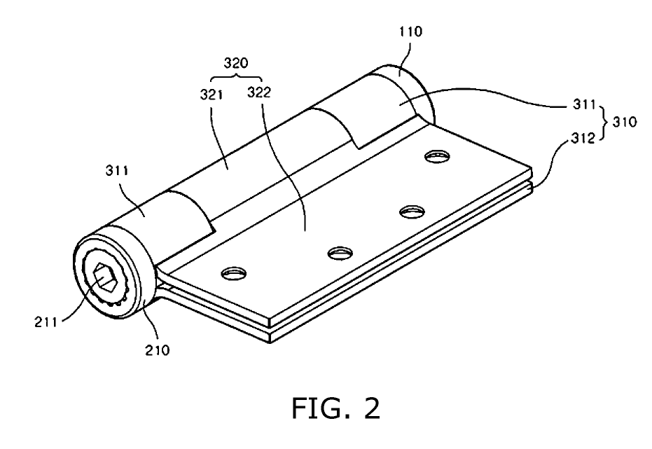

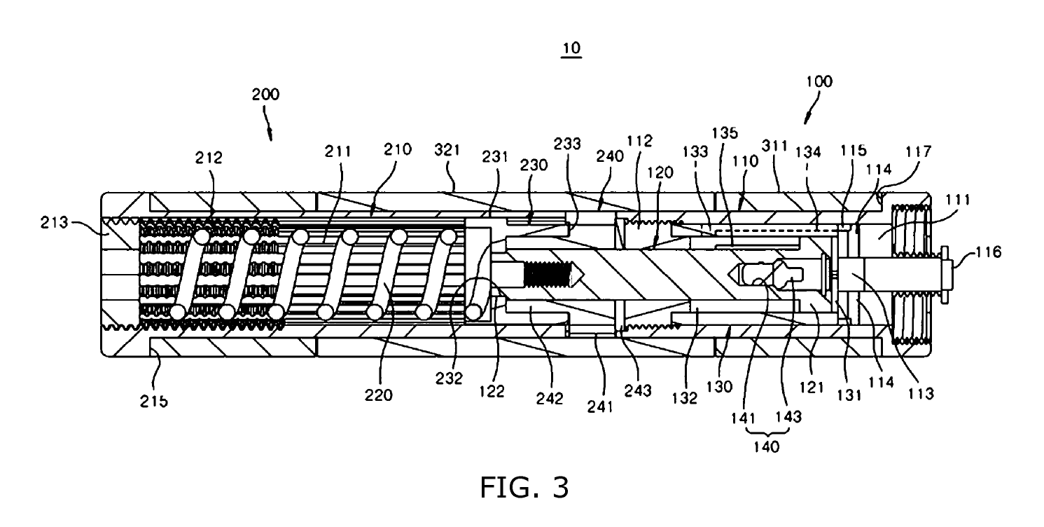

FIG. 1 is an exploded perspective view showing a closer according to one embodiment of the present invention, which shows a state in which the closer has been closed. FIG. 2 is a perspective view showing a hinge apparatus having the closer according to the one embodiment of the present invention. FIG. 3 is a sectional view showing the closer according to the one embodiment of the present invention.

The closer according to the embodiment of the present invention includes a damping device and a torsion device.

Referring to FIGS. 1 to 3, the damping device 100 of the closer according to the one embodiment of the present invention is provided in the closer 10, and may include a damping housing 110, a piston 120, a damping chamber 130, and an unidirectional control unit 140. The damping device 100 of the closer according to the one embodiment of the present invention may be used along with the torsion device 200. The torsion device 200 accumulates elastic energy by means of the opening force of a door. The torsion device 200 provides the cumulative elastic energy to the door when the force being applied to door is removed. The damping device 100 of the closer adjusts the speed at which the door is closed by providing damping force via the torsion device 200.

The damping device 100 of the closer according to one embodiment of the present invention, together with, e.g., the torsion device 200, is installed inside first and second housings 311 and 321 arranged in a line such that they can be rotated relative to each other in the hinge apparatus 300. The damping device 100 of the closer may be installed on one side of any one of the first and second housings 311 and 321, e.g., the first housing 311. The torsion device 200 may be fastened to the first and second housings 311 and 321 in order to provide restoring force attributable to torsion.

The closer of the torsion device 200 may be fastened to the first and second housings 311 and 321 in order to provide restoring force attributable to torsion. The damping device 100 may be installed on one side of any one of the first and second housings 311 and 321, e.g., the first housing 311.

In the present embodiment, the hinge apparatus 300 may include a pair of hinges, e.g., first and second hinges 310 and 320. In this case, the first hinge 310 may be configured such that a first housing 311 is provided with a first flap 312 configured to be fastened to any one of a door and a door frame by means of a screw, a bolt, or the like. The second hinge 320 may be configured such that the second housing 321 is provided with a second flap 322 configured to be fastened to the other one of the door and the door frame by means of a screw, a bolt, or the like. Furthermore, the first housing 311 may include a plurality of components, e.g., two components, and may be located on both ends of the second housing 321, as in the present embodiment. As another example, the first housing 311 may be located between the plurality of components, e.g., the two components, of the second housing 321.

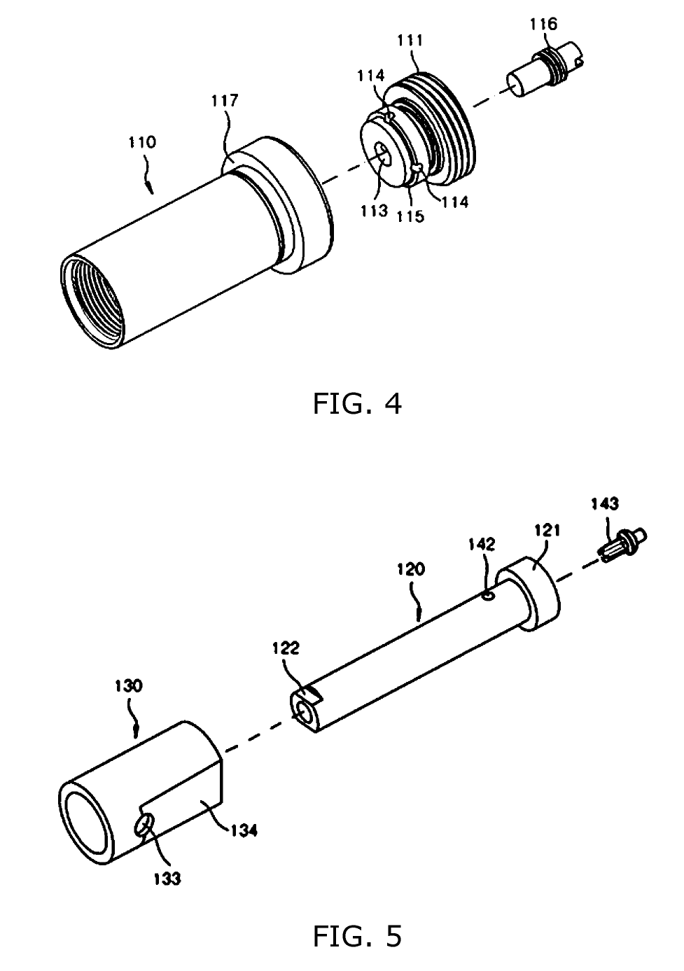

Referring to FIGS. 1, 3, and 4, the damping housing 110 is filled with working fluid, e.g., oil, first and second sealing parts 111 and 112 are provided on both ends of the damping housing 110 in order to achieve sealing, and connection flow paths 113, 114, and 115 configured to connect a center portion directed toward the piston 120 with an edge are formed in the first sealing part 111. In this case, the first sealing part 111 may be detachably fastened to the inside of one end of the damping housing 110 through screw coupling. The second sealing part 112 may be detachably fastened to the inside of the other end of the damping housing 110 through screw coupling, and may be provided with a through hole such that the piston 120 can pass through the second sealing part 112. Furthermore, in order to seal portions that are coupled to other components, sealing members, such as O-rings or the like, may be installed on the first and second sealing parts 112. Sealing members, such as O-rings or the like, may be installed on portions requiring sealing in the closer 10.

The damping housing 110 may be screwed to the first sealing part 111 such that a damping adjustment bolt 116 configured to adjust the extent to which the connection flow paths 113, 114 and 115 are opened and closed is exposed to the outside. The damping housing 110 is provided with a stop protrusion 117 so that the damping housing 110 is fitted into and caught on the first housing 311.

The connection flow paths 113, 114 and 115 may include: a first connection flow path 113 formed in the center portion of the first sealing part 111 to be connected to a first space 131; at least one second connection flow path 114 formed to extend from the first connection flow path 113 to an edge of the first sealing part 111; and a third connection flow path 115 formed along an edge on a side of the first sealing part 111 in contact with the damping chamber 130 to be connected to the second connection flow path 114. In this case, the second connection flow path 114 includes a plurality of branches, e.g., three branches, forked from the first connection flow path 113, and may be connected to the third connection flow path 115. The third connection flow path 115 may be configured in the form of a groove having a ring shape along the edge of the corner of an end of the first sealing part 111.

The damping adjustment bolt 116 may be screwed to the first sealing part 111 to be aligned with the first connection flow path 113. The damping adjustment bolt 116 may adjust the opening and closing of the first and second connection flow paths 113 and 114 through the tightening and loosening thereof, and may adjust damping force through the adjustment of the amount of working fluid to be passed through. In order to allow a jig to be inserted thereinto during rotation, a slotted recess, a cross recess, or a wrench recess may be formed in the damping adjustment bolt 116.

Referring to FIGS. 1, 3 and 5, the piston 120 passes through the second sealing part 112, is inserted into the damping housing 110, and is provided with a head 121 to be subject to the pressure of the working fluid. The piston 120 is reciprocated along with the sliding member 230 in an integrated manner in such a manner that a coupling part 122 provided at an end of a rod is inserted into the sliding member 230 of the torsion device 200 and fastened by a bolt or the like.

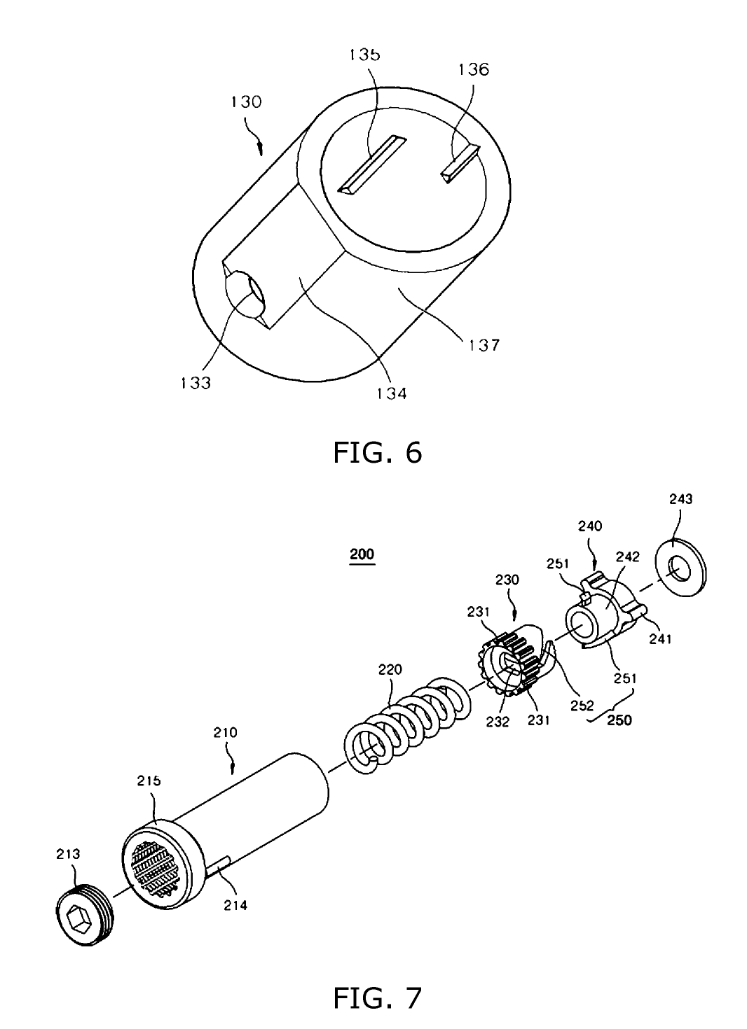

Referring to FIGS. 3, 5, and 6, the damping chamber 130 of the closer according to the one embodiment of the present invention may include a body 137 and main flow paths 133 and 134.

More specifically, referring to FIGS. 3, 5, and 6, the damping chamber 130 is fastened to the inside of the damping housing 110 so that the head 121 can be inserted into the damping housing 110. The internal space of the damping chamber 130 is divided into first and second spaces 131 and 132 in contact with the first and second sealing parts 111 and 112, respectively, by the head 121, the first space 131 is connected to the center portion, e.g., the first connection flow path 113, of the connection flow paths 113, 114 and 115, and the main flow paths 133 and 134 are formed to connect the edge side, e.g., the third connection flow path 115, of the connection flow paths 113, 114 and 115, which is blocked by an end, with the second space 132. Accordingly, a flow path for the working fluid is provided between the first and second spaces 131 and 132 for damping.

The body 137 is inserted and fastened into the damping housing 110 of the damping device 100, and thus an internal space 138 is filled with working fluid. The head 121 of the piston 120 of the damping device 100 is inserted into the internal space 138, and thus the internal space 138 is divided into first and second spaces 131 and 132 by the head 121. The internal space 138 of the body 137 is divided into the first and second spaces 131 and 132 in contact with the first and second sealing parts 111 and 112, respectively, by the head 121, and the first space 131 is connected to the center portion, e.g., the first connection flow path 113, of the connection flow paths 113, 114 and 115.

The body 137 may include, for example, a cylindrical hollow member having both open ends, and both ends of the body 137 may be fastened by the first and second sealing parts 111 and 112 within the damping housing 110.

The main flow paths 133 and 134 may include: a connection hole 133 formed in the side of the damping chamber 130 to connect the second space 132 with the outside; and a flow path groove 134 formed on the outer surface of the damping chamber 130 in a lengthwise direction to connect the connection hole 133 with the edge side, e.g., the third connection flow path 115, of the connection flow paths 113, 114 and 115, as in the present embodiment.

In other words, the main flow paths 133 and 134 connect the first and second spaces 131 and 132 with each other in association with the connection flow paths 113, 114 and 115 in such a manner that the flow path groove 134 is connected to the connection flow paths 113, 114 and 115 formed to be connected to the first space 131 and the edge side within the first sealing part 111 that blocks one end of the damping housing 110. In other words, the main flow paths 133 and 134 may connect the edge side, e.g., the third connection flow path 115, of the connection flow paths 113, 114 and 115, blocked by an end of the body 137, with the second space 132, thereby providing a flow path for the working fluid between the first and second spaces 131 and 132 for damping.

The flow path groove 134 may be formed in a planar shape by performing surface shaving from the connection hole 133 to an end in a lengthwise direction on the outer surface of the cylindrical body 137, thereby facilitating the formation of a flow path.

One or more adjustment flow paths 135 and 136 may be formed on the inner circumferential surface of the damping chamber 130 so that the working fluid can move between the first and second spaces 131 and 132 by bypassing the head 121. The adjustment flow paths 135 and 136 may be plural, e.g., two, in number, as in the present embodiment. When the head 121 of the piston 120 moves within the damping chamber 130, the working fluid to which pressure is applied by the head 121 moves from the first space 131 to the second space 132 or in the reverse direction by bypassing the head 121. By forming the adjustment flow paths 135 and 136, interval-based damping force or interval-based closing speed may be adjusted for the opening or closing region of the door corresponding to the location of the head 121 within the damping chamber 130. The adjustment flow paths 135 and 136 may be formed to have a length larger than the thickness of the head 121, and the location and length of the adjustment flow paths 135 and 136 within the damping chamber 130 may be determined by taking into account the location of the head 121 corresponding to an interval for which the adjustment of the closing speed of the door is required. Furthermore, the adjustment flow paths 135 and 136 may be formed to partially overlap each other as an example, may be formed to completely overlap each other as another example, or may be formed not to overlap each other as still another example. Alternatively, the adjustment flow paths 135 and 136 may be integrated with each other. The sectional area of the adjustment flow paths 135 and 136 may be determined by taking into account the amount of bypassing working fluid required for the adjustment of damping.

Referring to FIGS. 1, 3, and 5, the unidirectional control unit 140 is provided in the piston 120, and allows the working fluid to move between the first and second spaces 131 and 132 in a single direction while the piston 120 is moving. As an example, the unidirectional control unit 140 may be installed to move the working fluid in a direction reducing damping force when the door is open, e.g., a direction from the first space 131 to the second space 132, in a single direction, as in the present embodiment. The unidirectional control unit 140 may include, e.g.: control flow paths 141 and 142 formed in the piston 120 to connect the first and second spaces 131 and 132 with each other; and a check valve 143 configured to be installed in the control flow paths 141 and 142 and to allow only movement in a single direction from the first space 131 to the second space 132. In this case, the control flow paths 141 and 142 may include a first control flow path 141 formed to extend from the center of an end of the head 121 to the inner side in the piston 120, and a second control flow path 142 formed to be open from an end of the first control flow path 141 to the side of the piston 120. No matter where the piston 120 is located, the first control flow path 141 is connected to the first space 131, and the second control flow path 142 is connected to the second space 132. The check valve 143 may be installed within the first control flow path 141 through screw coupling, tight fitting, or the like. The check valve 143 may be configured to selectively open and close the first control flow path 141 in a single direction by limiting the moving direction of the working fluid by means of a ball elastically supported by a spring.

Referring to FIGS. 1, 3, and 7, the torsion device 200 may include a torsion housing part 210, a spring 220, a sliding member 230, a rotating member 240, and a rotational movement conversion unit 250.

Referring to FIGS. 3, 7, and 8, the torsion housing part 210 is fastened to any one hinge, e.g., the first hinge 310, of the hinge apparatus 300. One end of the torsion housing part 210 may be blocked, a plurality of sliding grooves 211 may be formed on the inner circumferential surface of the torsion housing part 210 in a lengthwise direction so that the sliding member 230 can be slidably coupled to the inner side of the torsion housing part 210, screw grooves 212 may be formed on the inner circumferential surface of an end of the torsion housing part 210, and a tension adjustment bolt 213 configured to support the spring 220 in the screw grooves 212 and to adjust the tension of the spring 220 according to the amount of rotation is screwed to the torsion housing part 210. The tension adjustment bolt 213 enables the compression and elasticity of the spring 220 to be adjusted in such a manner that the location of the tension adjustment bolt 213 within the torsion housing part 210 is varied through the rotation thereof, and functions to block one end of the torsion housing part 210 by means of a sealing member, such as an O-ring or the like. A jig coupling recess, such as a slotted recess, a cross recess, or a wrench recess, may be formed in the tension adjustment bolt 213 for the purpose of rotating the tension adjustment bolt 213.

At least one fastening protrusion 214 may be formed on the outer surface of the torsion housing part 210 in order to be fastened to the first housing 311 in a combined manner by being inserted into a fastening groove formed in the inside of the first housing 311 in the state of being inserted into the first housing 311 of the first hinge 310 fastened to any one of a door and a frame by means of the first flap 312 by using a screw, a bolt, or the like in the hinge apparatus 300. A stop protrusion 215 may be formed at an end of the torsion housing part 210 to secure an installation location when the torsion housing part 210 is inserted into the first housing 311.

Referring to FIGS. 1, 3, and 7, the spring 220 may be installed inside the torsion housing part 210 to provide elastic force in a lengthwise direction, and may include a coil compression spring, as in the present embodiment. One end of the spring 220 may be supported by the tension adjustment bolt 213, and the other end thereof may be supported by the sliding member 230.

The sliding member 230 is installed such that it is elastically supported by the spring 220 and can reciprocate in a lengthwise direction in the state in which the rotation thereof has been suppressed within the torsion housing part 210, and is coupled such that it can reciprocate along with the piston 120 of the damping device 100. A plurality of sliding protrusions 231 configured to be slidably coupled into the respective sliding grooves 211 may be formed along the circumference of the outer surface so that the sliding member 230 can reciprocate from the torsion housing part 210 in a state in which the rotation thereof has been suppressed. A coupling hole 232 may be formed in the sliding member 230 so that the coupling part 122 provided at an end of the piston 120 can be fitted into the coupling hole 232 and the sliding member 230 can be combined with the piston 120, and the coupling part 122 at the end of the piston 120 may be fastened using a coupling member, such as a bolt, a screw, or the like.

The rotating member 240 is installed to be rotated relative to the sliding member 230 in the state of being fitted over the piston 120 and fitted into the sliding member 230. The rotating member 240 is installed to be rotated relative to the sliding member 230 when the door is rotated in a state in which movement in a lengthwise direction has been suppressed. The rotating member 240 is fastened to the other hinge, e.g., the second hinge 320, of the hinge apparatus 300. The rotating member 240 is rotated relative to the sliding member 230 when the door is rotated. At least one fastening protrusion 241 configured to be fastened to the fastening groove provided on the second housing 321 of the second hinge 320 fastened to the other of the door and the door frame by means of the second flap 322 by using a bolt, a screw, or the like in the hinge apparatus 300 may be provided on the outer surface of the rotating member 240.

A fitting portion 242 may be formed on the rotating member 240 to be fitted into the sliding member 230. The fitting portion 242 may be formed on the sliding member 230 in an opposite manner. Furthermore, a washer 243 may be interposed between the rotating member 240 and the second sealing part 112 of the damping device 100. The washer 243 may be inserted into the piston 120, and may be installed inside the second housing 321. Furthermore, the relative rotation of the rotating member 240 is mentioned by taking into account both a case where the first hinge 310 of the hinge apparatus 300 is fastened to the door and the second hinge 320 is fastened to the door frame and a case where the first hinge 310 is fastened to the door frame and the second hinge 320 is fastened to the door in an opposite manner. When two cases, i.e., a case where the rotating member 240 is fastened to the door by the hinge apparatus 300 and the torsion housing part 210 is fastened to the door frame by the hinge apparatus 300 as an example and a case where the rotating member 240 is fastened to the door frame by the hinge apparatus 300 and the torsion housing part 210 is fastened to the door by the hinge apparatus 300, are taken into account, it may be meant that the rotating member 240 is rotated relative to the torsion housing part 210.

Referring to FIGS. 3, 7, and 9, the rotational movement conversion unit 250 converts the rotational movement of the rotating member 240 and the rectilinear movement of the sliding member 230 into each other in such a manner that guide protrusions 251 are formed on any one of the fitting portions of the sliding member 230 and the rotating member 240 to be inclined with respect to the reciprocating direction and guide grooves 252 configured to be combined with the guide protrusions 251 are formed on the other of the fitting portions of the sliding member 230 and the rotating member 240 to be inclined with respect to the reciprocating direction. In the rotational movement conversion unit 250, a plurality of guide protrusions 251, e.g., two guide protrusions 251, may be formed along the outer circumferential surface of the fitting portion 242 of the rotating member 240, and a plurality of guide grooves 252, e.g., two guide grooves 252, may be formed on the portion of the sliding member 230, into which the fitting portion 242 is fitted, to correspond to the guide protrusions 251, respectively.

A plurality of stop protrusions 233 may be formed along an end of the sliding member 230 so that the guide protrusions 251 separated from the guide grooves 252 are caught on the stop protrusions 233 and thus the closing of the door is stopped until external force is applied to the door.

The operation of the damping device of the closer according to the present invention will be described.

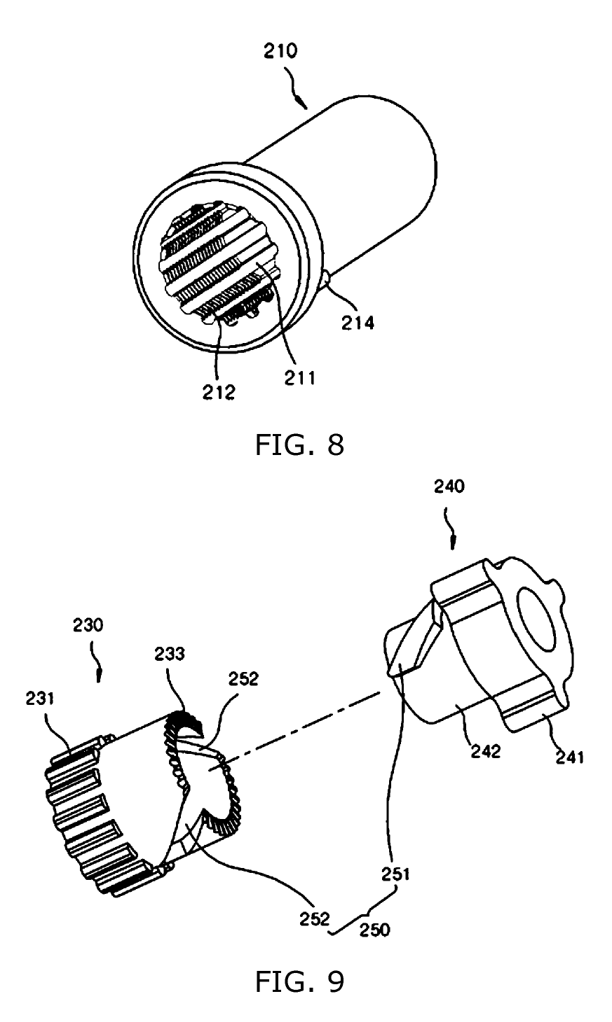

As shown in FIG. 3, when the angle formed by the first and second hinges 310 and 320 (shown in FIGS. 1, and 2) of the hinge apparatus 300 acting as an intermediary for the installation of the door on the door frame is 0 degrees because the door is closed, elastic force is provided from the spring 220 of the torsion device 200 to the sliding member 230, and the force applied from the sliding member 230 is transferred to the rotating member 240 by the rotational movement conversion unit 250 (shown in FIGS. 7, and 8), thereby maintaining a state in which the door has been closed. In this case, the guide protrusions 251 (shown in FIGS. 7, and 8) of the rotational movement conversion unit 250 are located within the guide grooves 252 (shown in FIGS. 7, and 8).

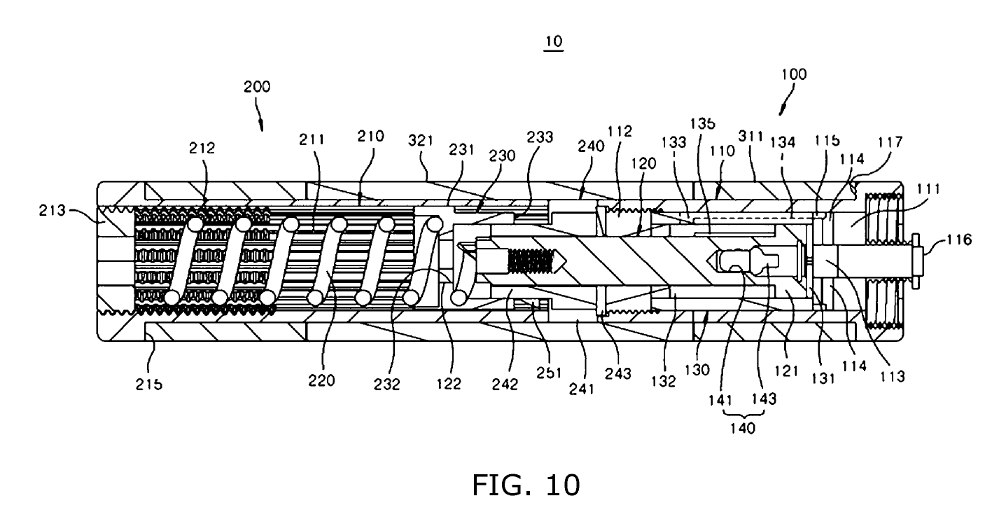

In this case, as shown in FIG. 10, when the door is opened by an angle of 45 degrees by applying force to the door, the first and second hinges 310 and 320 (shown in FIGS. 1, and 2) of the hinge apparatus 300 form an angle of degrees with each other. The rotating member 240 fastened to the second housing 321 of the second hinge 320 is rotated relative to the sliding member 230 by the opening force of the door, and the guide protrusions 251 (shown in FIGS. 7, and 8) of the rotational movement conversion unit 250 are moved along the guide grooves 252 (shown in FIGS. 7, and 8) by the rotation of the rotating member 240. Accordingly, the sliding member 230 starts rectilinear movement and compresses the spring 220, and accordingly elastic force starts to be accumulated in the spring 220.

In this case, as the piston 120 of the damping device 100 is moved along with the sliding member 230, the compression of the working fluid toward the second space 132 is started by the piston 120. In this case, the working fluid within the second space 132 moves to the first space 131 by sequentially passing through the main flow paths 133 and 135 and the connection flow paths 115, 114 and 113, i.e., the connection hole 133, the flow path groove 134, the third connection flow path 115, the second connection flow path 114, and the first connection flow path 113. As the check valve 143 is opened, the working fluid moves from the first space 131 to the second space 132 by sequentially passing through the control flow paths 141 and 142, i.e., the first control flow path 141 and the second control flow path 142. The door may be relatively easily opened by the unidirectional control unit 140. Meanwhile, the location of the piston 120 in a state in which the door is opened by 45 degrees shows little movement with respect to a location in a state in which the door is closed. This is based on the set slopes and curvatures of the guide protrusions 251 and the guide grooves 252, and they may be designed differently as desired.

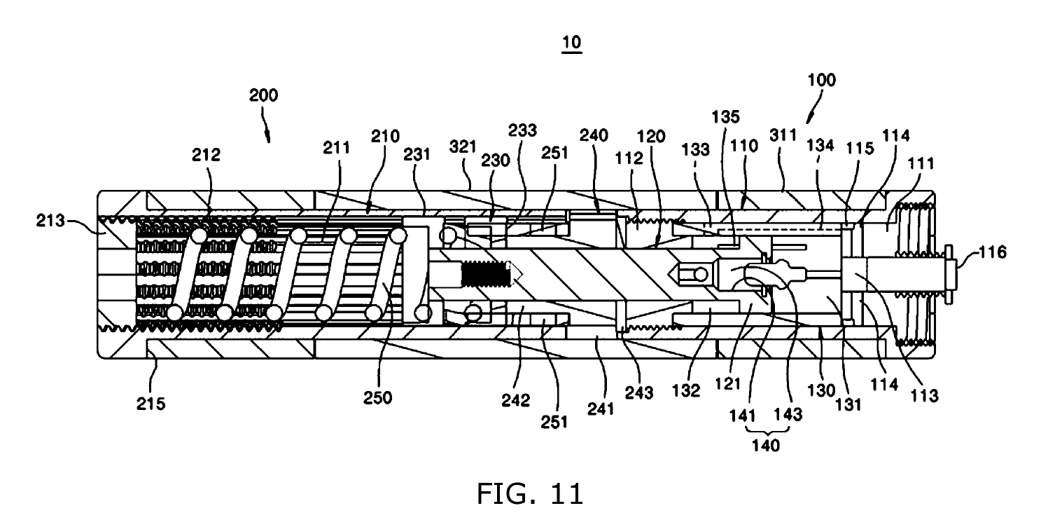

As shown in FIG. 11, when the door is opened by 90 degrees through the continuous opening of the door and thus the first and second hinges 310 and 320 (shown in FIGS. 1, and 2) form 90 degrees, the compression of the spring 220 and the movement of the working fluid, such as those described in conjunction with 45-degree opening, become greater, elastic force attributable to the compression of the spring 220 is provided as returning force by means of which the door is closed via the sliding member 230 and the rotating member 240.

When the force applied to the door is removed, elastic force accumulated in the spring 220 rectilinearly moves and returns the sliding member 230. As the guide protrusions 251 of the rotational movement conversion unit 250 are returned along the guide grooves 252, the rotating member 240 is rotated, thereby closing the door. In this case, the piston 120 is moved along with the sliding member 230 and compresses the working fluid toward the first space 132, and thus the working fluid within the first space 131 is moved to the second space 132 by sequentially passing through the connection flow paths 113, 114 and 115, the main flow paths 133 and 135, i.e., the first to third connection flow paths 113, 114 and 115, and the flow path groove 134 and the connection hole 133. In this case, as the check valve 143 is closed, the movement of the working fluid via the control flow paths 141 and 142 is blocked, and thus damping force is appropriately transferred to the door.

As described above, when the door installed via the hinge apparatus 300 is opened, the sliding member 230 is moved by the relative rotation of the rotating member 240 and the sliding member 230 and compresses the spring 220. When the force applied to the door is removed, the door is closed by the relative rotation of the sliding member 230 and the rotating member 240 based on the returning of the sliding member 230 attributable to the spring 220. In this case, the working fluid is compressed by the movement of the piston 120 which is moved along with the sliding member 230, and thus the working fluid moves between the first and second spaces 131 and 132 via all or part of the flow paths 113, 114, 115, 133, 134, 141 and 142 within the damping device 100, thereby generating damping force.

The damping force of the damping device 100 may be adjusted by the adjustment flow paths 135 and 136 provided in the damping chamber 130 to bypass the head 121 of the piston 120 on an interval basis, thereby adjusting the speed at which the door is closed on an interval basis.

While the present invention has been described with reference to the accompanying drawings as described above, it will be apparent that various modifications and alterations may be made without departing from the technical spirit of the present invention. Therefore, the scope of the present invention should be defined based on not only the attached claims but also equivalents to the attached claims.
100: damping device
110: damping housing
111: first sealing part
112: second sealing part
113, 114 and 115: connection flow path
116: damping adjustment bolt
117: stop protrusion
120: piston
121: head
122: coupling part
130: damping chamber
131: first space
132: second space
133 and 134: main flow path
135 and 136: adjustment flow path
137: body
138: internal space
140: unidirectional control unit
141 and 142: control flow path
143: check valve
200: torsion device
210: torsion housing part
211: sliding groove
212: screw groove
213: tension adjustment bolt
214: fastening protrusion
215: stop protrusion
220: spring
230: sliding member
231: sliding protrusion
232: coupling hole
233: stop protrusion
240: rotating member
241: fastening protrusion
242: fitting portion
243: washer
250: rotational movement conversion unit
251: guide protrusion
252: guide groove
300: hinge
310: first hinge
311: first housing
312: first flap
320: second hinge
321: second housing
322: second flap

1. A closer comprising a damping device, the damping device comprising:
a damping housing configured such that both ends thereof are sealed by first and second sealing parts, and such that connection flow paths configured to connect a center portion in a lengthwise direction with an edge is formed in the first sealing part;
a piston configured to pass through the second sealing part and to be inserted into the damping housing, and provided with a head to be subject to pressure of working fluid; and
a damping chamber configured such that an internal space thereof is divided into first and second spaces in contact with the first and second sealing parts, respectively, by the head, and such that a flow path for working fluid is provided between the first and second spaces.

2. The closer of claim 1, wherein the closer further comprises a torsion device configured to be coupled to the damping device, and the torsion device comprises:
a sliding member configured to be coupled to the piston of the damping device so that they can reciprocate together; and
a rotating member configured to be fitted over the piston, to be inserted into the sliding member, to be installed to rotate relative to the sliding member.

3. The closer of claim 1, wherein the connection flow paths of the damping housing of the damping device are formed to connect a center portion of a side directed toward the piston with an edge within the first sealing part, the damping chamber is fastened to an inside of the damping housing so that the head is inserted thereinto, the first space is connected to a center portion of the connection flow paths, and the main flow paths are formed to connect an edge side of the connection flow paths, which is blocked by an end, with the second space, thereby providing a flow path for the working fluid between the first and second spaces for damping, and the damping device further comprises a unidirectional control unit provided in the piston and configured to allow the working fluid to move between the first and second spaces in a single direction while the piston is moving.

4. The closer of claim 3, wherein the damping housing is screwed to the first sealing part such that a damping adjustment bolt configured to adjust an extent to which the connection flow paths are opened and closed is exposed to an outside.

5. The closer of claim 3, wherein the connection flow paths comprise:
a first connection flow path formed in a center portion of the first sealing part to be connected to the first space;
at least one second connection flow path formed to extend from the first connection flow path to an edge of the first sealing part; and
a third connection flow path formed along an edge on a side of the first sealing part in contact with the damping chamber to be connected to the second connection flow path.

6. The closer of claim 3, wherein the main flow paths comprise:
a connection hole formed through a side of the damping chamber to connect the second space with an outside; and
a flow path groove formed through an outer surface of the damping chamber in a lengthwise direction to connect the connection hole with the edge side of the connection flow paths.

7. The closer of claim 3, wherein one or more adjustment flow paths are formed on an inner circumferential surface of the damping chamber so that the working fluid can move between the first and second space by bypassing the head.

8. The closer of claim 3, wherein the unidirectional control unit comprises:
control flow paths formed in the piston to connect the first and second spaces with each other; and
a check valve configured to be installed in the control flow paths and to allow movement in a single direction from the first space to the second space.

9. The closer of claim 3, wherein the damping chamber comprises:
a body; and
main flow paths including a connection hole formed in a side of the body to connect the second space with an outside, and a flow path groove formed on an outer surface of the body to connect the connection hole with the first space, thereby providing a flow path for the working fluid separate from the head that reciprocates.

10. The closer of claim 9, wherein:
the body includes a cylindrical member having both open ends; and
the flow path groove is formed through surface shaving on an outer surface of the body to extend from the connection hole to an end.

11. The closer of claim 9, wherein the main flow paths connect the first and second spaces with each other in association with the connection flow paths in such a manner that the flow path groove is connected to the connection flow paths formed to be connected to the first space and the edge side within the first sealing part that blocks one end of the damping housing.

12. The closer of claim 9, wherein one or more adjustment flow paths are formed on an inner circumferential surface of the damping chamber so that the working fluid can move between the first and second space by bypassing the head.

13. The closer of claim 12, wherein the damping chamber is configured such that the adjustment flow paths are plural in number and partially overlap each other based on a direction in which the head reciprocates.

14. The closer of claim 2, wherein:
the torsion device comprises:
a torsion housing part fastened to any one hinge of a hinge apparatus; and
a spring installed within the torsion housing part in a lengthwise direction to provide elastic force;
the sliding member is installed to be elastically supported on the spring and to reciprocate in the lengthwise direction in a state in which rotation of the sliding member has been suppressed within the torsion housing part;
the rotating member is fastened on a remaining hinge of the hinge apparatus;
the torsion device further comprises a rotational movement conversion unit configured to convert rotational movement of the rotating member and rectilinear movement of the sliding member into each other in such a manner that guide protrusions are formed on any one of fitting portions of the sliding member and the rotating member to be inclined with respect to a reciprocating direction and guide grooves configured to be combined with the guide protrusions are formed on a remaining one of the fitting portions of the sliding member and the rotating member to be inclined with respect to the reciprocating direction; and
when the door on which the hinge apparatus is installed is opened, the sliding member is moved by relative rotation of the rotating member and the sliding member and compresses the spring, and, when force applied to the door is removed, the door is closed by relative rotation of the sliding member and the rotating member based on returning of the sliding member attributable to the spring.

15. The closer of claim 14, wherein the torsion housing part is configured such that a plurality of sliding grooves is formed on an inner circumferential surface of the torsion housing part in a lengthwise direction so that the sliding member can be slidably coupled to an inner side of the torsion housing part, screw grooves are formed on an inner circumferential surface of an end of the torsion housing part, and a tension adjustment bolt configured to support the spring in the screw grooves and to adjust tension of the spring according to an amount of rotation is screwed to the torsion housing part.

16. The closer of claim 15, wherein sliding protrusions configured to be slidably coupled into the sliding grooves in a state in which rotation thereof has been suppressed are formed on a circumferential surface of the sliding member.

17. The closer of claim 16, wherein at least one fastening protrusion configured to be fastened to a housing of the hinge apparatus is formed on an outer surface of each of the torsion housing part and the rotating member.

18. The closer of claim 14, wherein the rotational movement conversion unit is configured such that the guide protrusions are formed along an outer circumferential surface of a fitting portion of the rotating member and the guide grooves are formed on a portion of the sliding member, into which the fitting portion is fitted, to correspond to the respective guide protrusions.

19. The closer of claim 18, wherein a plurality of stop protrusions are formed along an end of the sliding member so that the guide protrusions separated from the guide grooves are caught on the stop protrusions and thus closing of the door is stopped until external force is applied to the door.

20. A damping device for a closer, the damping device comprising:
a damping housing configured such that both ends thereof are sealed by first and second sealing parts, and such that connection flow paths configured to connect a center portion in a lengthwise direction with an edge is formed in the first sealing part;
a piston configured to pass through the second sealing part and to be inserted into the damping housing, and provided with a head to be subject to pressure of working fluid; and
a damping chamber configured such that an internal space thereof is divided into first and second spaces in contact with the first and second sealing parts, respectively, by the head, and such that a flow path for working fluid is provided between the first and second spaces.

21. The damping device of claim 20, wherein the damping chamber is fastened to an inside of the damping housing, the first space is connected to a center portion of the connection flow paths, and the main flow paths are formed to connect an edge side of the connection flow paths, which is blocked by an end, with the second space, thereby providing a flow path for the working fluid between the first and second spaces for damping.
